(19) United States
(12) Patent Application Publication
(10) Pub. No.: US 2008/0144102 A1
(43) Pub. Date: Jun. 19, 2008

(54) SCANNED DOCUMENT COVER SHEET

(76) Inventor: Donald J. Curry, Menlo Park, CA (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/611,203

(22) Filed: Dec. 15, 2006

(51) Int. Cl. H04N 1/32

(52) U.S. Cl. 358/1.16

(57) ABSTRACT

The embodiments herein provide a method for maintaining information about scanned documents that keeps such information with the physical documents. With embodiments herein this information is maintained in both physical (printed cover sheets) and electronic formats (magnetic media, optical media, electronic storage, etc.). The embodiments herein scan a physical document into electronic memory as a first electronic document. In addition, the methods herein print markings on a cover sheet to be maintained with the physical document that was scanned. The markings are described as being computer readable information because the markings are computer readable and comprise information such as scan parameters and an electronic storage location of the first electronic document.

### BACKGROUND

Embodiments herein generally relate to electrostatographic printers and copiers or reproduction machines, and more particularly, concerns a cover sheet used with a scanned document, a method for generating and using the cover sheet, and a computer program product for performing the method.

It is very common for printed documents to be scanned into electronic form for storage, transmission, copying, etc. After being scanned, the printed documents can then be destroyed or stored in physical storage. For example, as explained in U.S. Pat. No. 6,963,413, the complete disclosure of which is incorporated herein by reference, today's printers utilize a wide range of different printing technologies to make marks on paper, and new approaches are being developed continually. Each technology has its own unique print quality characteristics, and as a result, different printers typically yield different output quality when given the same input data. In the case of traditional printing, much of the data submitted to a printer was orthographic in origin (computer generated). Typically, orthographic data is described using some sort of PDL (page description language), wherein commands are sent to a RIP (raster image processor) that in return create/render device specific rasters for sending to the print engine. However, with the growing popularity of scanners, digital cameras, and print ready masters used in print-on-demand applications, there is a tremendous amount of reprographic (scanned/pre-rasterized images) data also being sent directly to printers today.

With respect to some details regarding scanners and other associated hardware, U.S. Pat. No. 6,738,158 (the complete disclosure of which is incorporated herein by reference) explains that, in a conventional digital scanner, a light source is used to illuminate a document having the image to be scanned. The conventional digital scanner also includes a platen glass upon which the document rests and a platen cover. The light emitted by the light source illuminates the document and is reflected off and imaged by an optical system or lens system towards either a CCD sensor array or full width array, which converts the reflected light into electrical signals which are eventually converted into digital image data. An image processing circuit electronically registers the image, and converts the electrical signals into digital image data so that the digital image data can be utilized by an image output terminal, network, or memory device.

A printer or other digital imaging system is typically coupled to a digital scanner for scanning an original image (e.g. document) and employs an initial step of charging a photoconductive member (photoreceptor) to a substantially uniform potential. The charged surface of the photoconductive member is thereafter exposed to a light image of an original document to selectively dissipate the charge thereon in selected areas irradiated by the light image. This procedure records an electrostatic latent image on the photoconductive member corresponding to the informational areas contained within the original document being reproduced. The latent image is then developed by bringing a developer including toner particles adhering triboelectrically to carrier granules into contact with the latent image. The toner particles are attracted away from the carrier granules to the latent image, forming a toner image on the photoconductive member, which is subsequently transferred to a copy sheet. The copy sheet having the toner image thereon is then advanced to a fusing station for permanently affixing the toner image to the copy sheet.

The approach utilized for multicolor electrostatographic printing is substantially identical to the process described above. However, rather than forming a single latent image on the photoconductive surface in order to reproduce an original document, as in the case of black and white printing, multiple latent images corresponding to color separations are sequentially recorded on the photoconductive surface. Each single color electrostatic latent image is developed with toner of a color complimentary thereto and the process is repeated for differently colored images with the respective toner of complimentary color. Thereafter, each single color toner image can be transferred to the copy sheet in superimposed registration with the prior toner image, creating a multi-layered toner image on the copy sheet. Finally, this multi-layered toner image is permanently affixed to the copy sheet in substantially conventional manner to form a finished copy.

Further, with respect to machine readable markings, bar codes and glyphs are discussed at length in U.S. Pat. No. 6,457,651 (the complete disclosure of which is incorporated herein by reference). U.S. Pat. No. RE38758 (the complete disclosure of which is incorporated herein by reference) explains that plain paper still is a favored recording medium for storing and transferring human readable information, but the emergence of electronic documents processing systems has made it evident that the functional utility of plain paper and other types of hardcopy documents could be enhanced significantly if the human readable information they normally convey was supplemented by writing appropriate machine readable digital data on them. This machine readable data would enable the hardcopy document to actively interact with such a document processing system in a variety of different ways when the document is scanned into the system by an ordinary input scanner. As a general rule, digital data is received by writing two dimensional marks on a recording medium in accordance with a pattern which encodes the data either by the presence or absence of marks at a sequence of spatial locations or by the presence or absence of mark related transitions at such locations. Ordinary magnetic and optical digital data recording conform to this style of encoding. Furthermore, the bar-like codes which have been proposed previously for recording digital data on paper also conform to the above-described encoding style.

### SUMMARY

While the concepts of scanning documents into electronic formats and of using machine readable markings is discussed above, once a document is scanned it is usually stored in a physical location or destroyed. The embodiments herein provide a method for maintaining information about scanned documents that keeps such information with the physical documents. With embodiments herein this information can be maintained in both physical (printed cover sheets) and electronic formats (magnetic media, optical media, electronic storage, etc.). The embodiments herein scan a physical document into electronic memory as a first electronic document. In addition, the methods herein print markings on a cover sheet to be maintained (at least temporarily) with the physical document that was scanned. The markings are described as being computer readable information because the markings are computer readable and comprise information such as scan parameters and an electronic storage location of the first electronic document.

The printed markings can be only machine readable (e.g., bar codes and glyphs) or can also include human-readable markings (text, symbols, etc.). A non-exhaustive list of possible types of information that the markings can contain includes the name of the first (or subsequent) electronic document(s); an index identifier in a database; the scanning date; the scanning location; the scanner name; the scanner operator name; and a physical storage location.

Thus, with embodiments herein, when the physical document and the cover sheet are rescanned (as a second electronic document), the method can reuse the previous scan parameters and can store the second electronic document as a replacement of the first electronic document, as opposed to a duplicate new document. Thus, when a document is rescanned with the cover sheet, the first electronic document can be erased and the second electronic document can be automatically stored in place of the first electronic document.

The embodiments herein can also associate an electronic data file containing the computer readable information with the first or second (and subsequent) electronic documents. Therefore, if the user has the physical cover sheet, the user can read from or scan the physical cover sheet to locate the electronic version of the previously scanned document and learn of the details of the previous scan. Similarly, if the user has access to the electronic data file, the user can learn of the scanning details and of the physical location of the printed document that was scanned.

Many uses flow from the cover sheet that is printed and the electronic data file that is created. For example, the embodiments herein can issue an instruction to rescan the physical document if the scan parameters indicate that the scanning was performed at a level below a predetermined standard. In addition, during scans that follow the initial scans (rescans) the method can translate the markings on the cover sheet to produce the previous scan parameters and to reveal the electronic storage location of the electronic version of the scanned document. If desired, the previous scan parameters can be reused during creation of the second (or subsequent) electronic document. Further, by knowing the electronic location of the first (or previous) electronic scanned document, the embodiments here can overwrite the previous electronic scanned document, to eliminate redundant documents.

The cover sheet can comprise a sheet of different weight, a colored sheet, an offset sheet, etc. so that the cover sheet can also serve as a divider sheet which physically separates the scanned physical document from other physical documents.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flowchart illustrating method steps of embodiments herein;

FIG. 2 is a schematic diagram of a cover sheet produced according to embodiments herein; and

FIG. 3 is a schematic diagram of a system used with embodiments herein.

### DETAILED DESCRIPTION

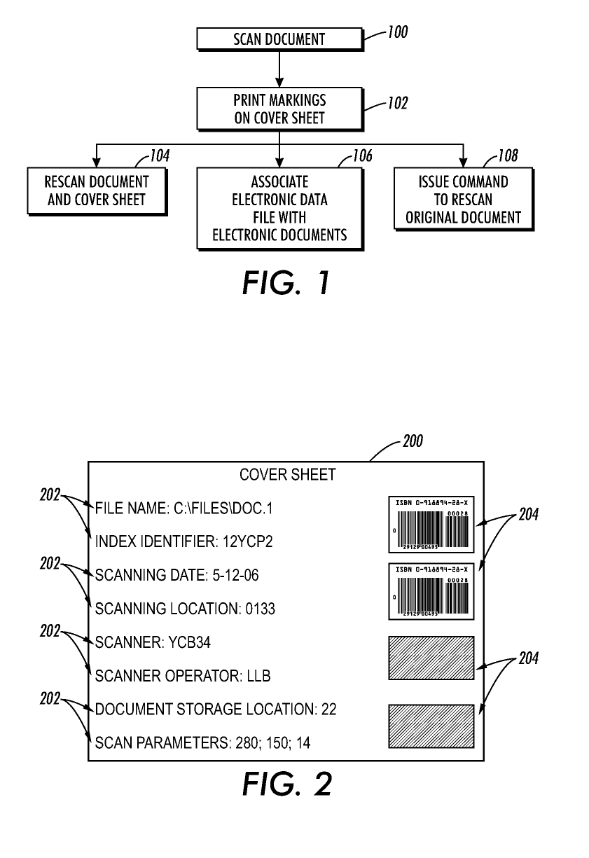

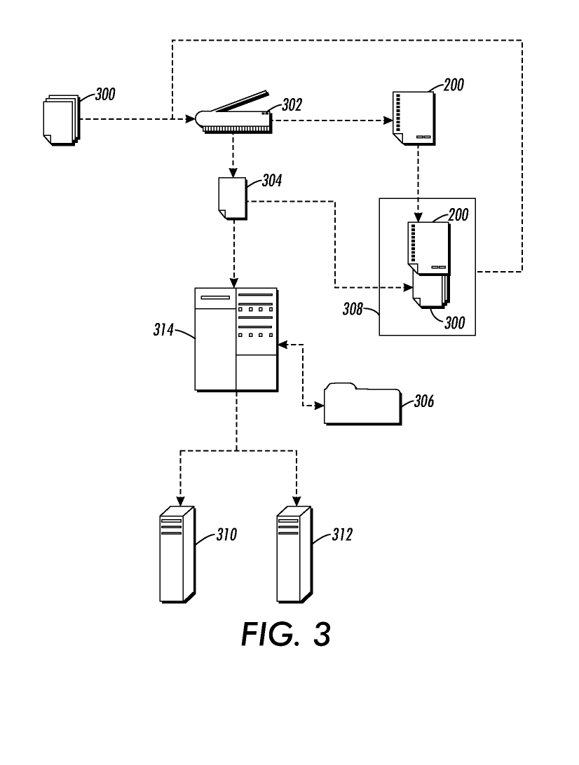

Embodiments herein provide a method for maintaining information about scanned documents, as shown for example in flowchart form in FIG. 1. With embodiments herein this information is maintained in both physical (printed cover sheets 200, shown in FIG. 2) and electronic (magnetic media 310, optical media 312, electronic storage 314, etc., shown in FIG. 3) formats.

One feature of scanned documents is the ability to move a business from a paper-based format to a paperless, electronic format. However, during transition to a paperless environment, or during the day-to-day conversion of paper documents into electronic documents, it may be necessary to maintain the paper copy of a document that is scanned for a certain period of time. For example, one person or department may be responsible for the physical process of scanning paper documents and a different person or department may be responsible for reviewing/evaluating the quality of the scanned document. Therefore, it may be necessary to perform a rescan of a given document some time after it was originally scanned, if the scanned document does not comply with a predetermined quality standard. The embodiments herein provide assistance in such rescanning, by allowing the cover sheet to include computer-readable information, such as the previous scan parameters, the file name and electronic storage location, the proper physical storage location, the scanner used, the scan operator, etc. By including such information on the cover sheet, if a user has the scanned document in hand, they can know where the document should be located (if it needs to be stored), the file name (and electronic storage location), the scan parameters, who performed the scan, which scanner was used, etc. Similarly, if a user has electronic access to the scanned document, the user can also determine the physical location of the physical location of the document, who scanned the document, the scan parameters, etc. to facilitate any necessary rescanning.

In addition, physical documents can be altered from time to time (e.g., signatures and annotations can be added, etc.). After physical alteration, with embodiment herein, the user can simply perform a rescan of the physically altered document (without any knowledge of the electronic document file name or electronic storage location) and have the most current version of the physical document be associated with the previously created electronic document (or to automatically replace the previously created electronic document) so that the most current version of an electronic document will always be available to the user when any version of the electronic document is accessed (or so that the user can be prevented from accidentally accessing an older version of a an electronic document when the most current version was desired).

As shown in item 100 in FIG. 1, the embodiments herein can scan a physical document 300 into electronic memory 314 as a first electronic document 304 (FIG. 3). For example, the embodiments herein can work with any commonly available multi-function device 306 or combination of separate devices which can, in combination or separately, scan and print. In addition, in item 102, the methods herein print markings 202 (FIG. 2) on a cover sheet 200 to be maintained with the physical document 300 that was scanned in a document storage location 308. The markings 202 are described as being computer readable information because the markings 202 are computer readable and comprise information such as scan parameters and a file name/electronic storage location of the first electronic document 304.

The printed markings can be only machine readable 202 (e.g., bar codes and glyphs) or can also include human-readable markings 204 (text, symbols, etc.). A non-exhaustive list of possible types of information that the markings 202, 204 can contain includes the name of the first (or subsequent) electronic document(s); an index identifier in a database; the scanning date; the scanning location; the scanner name; the scanner operator name; and a physical storage location.

Thus, with embodiments herein, when the physical document 300 and the cover sheet 200 are rescanned (as a second electronic document) in item 104 of FIG. 1, the method can reuse the previous scan parameters and can store the second electronic document as a replacement of the first electronic document 304, as opposed to a duplicate new document. Thus, when a document 300 is rescanned with the cover sheet 200 in item 104, the first electronic document 304 can be erased and the second electronic document can be stored in place of the first electronic document 304 in the electronic storage locations 314, optical storage locations 310, magnetic storage locations, 312 etc. The electronic storage locations 314, optical storage locations 310, magnetic storage locations, 312 etc. can comprise any form of computing/storage device whether presently known or developed in the future. In addition, any of such devices 310, 312, 314, etc. can include a computer program product that comprises a computer-usable data carrier storing instructions that, when executed by the computer, cause the computer to perform the method of embodiments described herein.

The embodiments herein can also associate an electronic data file 306 containing the computer readable information with the first or second (and subsequent) electronic documents 304 in item 106. Therefore, if the user has the physical cover sheet 200, the user can read from or scan all or portions of the physical cover sheet 200 to determine the electronic storage location 310, 312, 314, etc. of the electronic version of the previously scanned document 304 and learn of the details of the previous scan (from the contents of the electronic data file 306). Similarly, if the user has access to the electronic data file 306, the user can learn of the scanning details and of the physical location 308 of the printed document that was scanned.

Many uses flow from the cover sheet 200 that is printed and the electronic data file 306 that is created. For example, in item 108, the embodiments herein can issue an instruction to rescan the physical document 300 if the scan parameters indicate that the scanning was performed at a level below a predetermined standard. Because the electronic data file 306 includes the physical storage location 308 of the physical document 300 and because the cover sheet 200 is on top of the physical document 300, the operator can more easily locate the physical document and perform the rescanning process.

In addition, during scans that follow the initial scans (rescans) the method can translate the markings 202 on the cover sheet 200 into the previous scan parameters to reveal the electronic storage location 310, 312, 314, etc., of the electronic version 304 of the scanned document. A new coversheet 200 can be printed after each scan, but does not need to be. If desired, the previous scan parameters can be reused during creation of the second (or subsequent) electronic document. Further, by knowing the electronic location 310, 312, 314, etc., of the first (or previous) electronic scanned document 304, the embodiments here can automatically overwrite the previous electronic scanned document, to eliminate redundant documents, save storage space, reduce user confusion and potential error of using an out of date scanned document.

The word “printer” or “image output terminal” as used herein encompasses any apparatus, such as a digital copier, bookmaking machine, facsimile machine, multi-function machine, etc. which performs a print outputting function for any purpose. The details of printers, printing engines, etc. are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the invention should not be implied or imported from any above example as limitations to any particular order, number, position, size, shape, angle, color, or material.

What is claimed is:

1. A method comprising:
scanning a physical document into electronic memory as a first electronic document;
printing markings on a cover sheet to be maintained with said physical document, wherein said markings comprise computer readable information; and
associating an electronic data file containing said computer readable information with said first electronic document.

2. The method according to claim 1, wherein said computer readable information comprises scan parameters and an electronic storage location of said first electronic document.

3. The method according to claim 2, further comprising issuing an instruction to rescan said physical document if said scan parameters indicate that said scanning was performed at a level below a predetermined standard.

4. The method according to claim 1, wherein said markings include human-readable markings and said cover sheet comprises a divider sheet adapted to physically separate said physical document from other physical documents.

5. The method according to claim 4, wherein said human-readable markings include at least one of a name of said first electronic document; an index identifier in a database; a scanning date; a scanning location; a scanner name; a scanner operator name; and a physical storage location.

6. The method according to claim 1, wherein said computer readable information comprises at least one of: a name of said first electronic document; an index identifier in a database; a scanning date; a scanning location; a scanner name; and a scanner operator name.

7. The method according to claim 1, wherein said markings comprise one of bar codes and glyphs.

8. A method comprising:
scanning a physical document into electronic memory as a first electronic document;
printing markings on a cover sheet to be maintained with said physical document, wherein said markings comprise computer readable information comprising scan parameters and an electronic storage location of said first electronic document;
associating an electronic data file containing said computer readable information with said first electronic document;
rescanning said physical document and said cover sheet as a second electronic document;
storing said second electronic document as a replacement of said first electronic document and not as a new document such that said first electronic document is erased and said second electronic document is stored in place of said first electronic document; and
associating said electronic data file with said second electronic document.

9. The method according to claim 8, further comprising issuing an instruction to rescan said physical document if said scan parameters indicate that said scanning was performed at a level below a predetermined standard.

10. The method according to claim 8, further comprising:
translating said markings into said scan parameters and said electronic storage location during said rescanning;
using said scan parameters during creation of said second electronic document; and
using said electronic storage location to store said second electronic document.

11. The method according to claim 8, wherein said markings include human-readable markings and said cover sheet comprises a divider sheet adapted to physically separate said physical document from other physical documents.

12. The method according to claim 11, wherein said human-readable markings include at least one of a name of said first electronic document; an index identifier in a database; a scanning date; a scanning location; a scanner name; a scanner operator name; and a physical storage location.

13. The method according to claim 8, wherein said computer readable information comprises at least one of: a name of said first electronic document; an index identifier in a database; a scanning date; a scanning location; a scanner name; and a scanner operator name.

14. The method according to claim 8, wherein said markings comprise one of bar codes and glyphs.

15. A cover sheet adapted to be maintained with a physical document, said cover sheet comprising:
markings, wherein said markings comprise computer readable information relating to a first electronic document produced during a scan performed of said physical document and comprise scan parameters and an electronic storage location of said first electronic document.

16. The cover sheet according to claim 15, wherein said markings include human-readable markings and said cover sheet comprises a divider sheet adapted to physically separate said physical document from other physical documents.

17. The cover sheet according to claim 16, wherein said human-readable markings include at least one of a name of said first electronic document; an index identifier in a database; a scanning date; a scanning location; a scanner name; a scanner operator name; and a physical storage location.

18. The cover sheet according to claim 15, wherein said computer readable information comprises at least one of: a name of said first electronic document; an index identifier in a database; a scanning date; a scanning location; a scanner name; and a scanner operator name.

19. The cover sheet according to claim 15, wherein said markings comprise one of bar codes and glyphs.

20. A computer program product comprising:
a computer-usable data carrier storing instructions that, when executed by a computer, cause the computer to perform a method comprising:
scanning a physical document into electronic memory as a first electronic document;
printing markings on a cover sheet to be maintained with said physical document, wherein said markings comprise computer readable information; and
associating an electronic data file containing said computer readable information with said first electronic document.
